(19) United States
(12) Patent Application Publication
(10) Pub. No.: US 2025/0060486 A1
(43) Pub. Date: Feb. 20, 2025

(54) DEVICE AND METHOD FOR AUTONOMOUS POSITIONING OF VEHICLES

(71) Applicants: GTS FRANCE, Vélizy-Villacoublay (FR); THALES (CHINA) ENTERPRISES MANAGEMENT CO., LTD, BEIJING, CHAOYANG DISTRICT (CN)

(72) Inventors: Philippe LAVIRON, VELIZY (FR); Marc REVOL, UPIE (FR); Alex ZHANG, BEIJING, CHAOYANG DISTRICT (CN); Jeffrey YU, BEIJING, CHAOYANG DISTRICT (CN)

(21) Appl. No.: 18/724,316

(22) PCT Filed: Dec. 29, 2022
(86) PCT No.: PCT/EP2022/088044

§ 371 Date: Jun. 26, 2024

(30) Foreign Application Priority Data
Dec. 29, 2021 (FR) 2114635

(51) Int. Cl. G01S 19/14; B61L 25/02; G01S 19/22; G01S 19/42; G01S 19/50

(52) U.S. Cl. CPC G01S 19/14; B61L 25/025; G01S 19/22; G01S 19/423; G01S 19/50

(57) ABSTRACT

A positioning device for determining the location of a vehicle stationary or moving on roads of a given network from positioning signals broadcasted by satellites of at least one constellation of satellites, comprising: a first unit determining a plurality of possible current positions and a plurality of time stamps, configured to: generate local replicas of positioning signals; receive, positioning signals broadcasted by one or more satellites in view; process, for each possible current position and time stamp, a correlation function between a received positioning signal and a local replica; a second unit: determining a common error to all the satellites, correcting the correlation results using the common error, determining, for each possible current position of the vehicle, multi-satellite likelihoods; determining a position and time stamp by comparing the multi-satellite likelihoods.

### TECHNICAL FIELD

The invention generally relates to positioning systems and in particular to a device and a method for the autonomous positioning of vehicles using positioning signals provided by at least one constellation of satellites without need of the position of a previous time or train movement.

### BACKGROUND

Rail transport has become an efficient solution for transporting people and transporting freight. Compared to road transport, for example, rail transport has the advantage of being cost effective, more environmentally friendly, capable of hauling large loads, and more reliable as the trains do not share their tracks with the public like trucks do with the road. As a direct consequence of these advantages, the deployment of railway networks has known a rapid growth during the last two decades, particularly in countries experiencing significant social and/or economic progress. In order to meet an ever-growing demand for more efficient, faster and cleaner rail transport, the number of trains sharing a same railway network, as well as their speed, is continuously growing. Thus, the management of a railway network has become a task of paramount importance in order to ensure a certain level of safety, in particular when passengers are involved. An essential requirement for the efficient management of a railway network is the ability to locate precisely, in real-time, each of the trains running or being stopped on the tracks of the railway network.

A known solution for determining the location of a train running on the tracks of a railway network consists in deploying electronic beacons, also called balises, along the tracks, the electronic beacons being connected wirelessly or wired to a central control unit. The operating principle of an electronic beacon consists in detecting, by means of a mechanical or an electronic mechanism, any train passing over it. When a train is detected, the electronic beacon instantly transmits a detection signal that contains an identifier of the electronic beacon and may comprise information about the passing train. In some cases, the electronics beacons may be configured to interact, i.e. exchange signals, with the passing train. In those cases, the passing train may carry out the transmission of the detection signals to central control unit. The deployment and the maintenance of such a solution turn quickly out to be costly as a huge number of electronic beacons are required in both high-speed railway network where the distance between adjacent stations is typically higher than few kilometers and metro railway network where a high precision is strongly required despite the short distance between adjacent stations. Such a solution has also the drawback of being compatible only with moving trains in a context where it is also necessary to locate the stationary trains. In addition, it is impossible to locate a train running or stationary between two adjacent electronic beacons using such solution.

Another known solution for determining the location of a running or a stationary train on the tracks of a railway network consists in using global navigation satellite systems (GNSS) by equipping each train with a GNSS receiver. Such a solution allows overcoming the requirement for the deployment of beacons along the tracks. Generally, a GNSS receiver operates independently of the railway network by computing a three-dimensional (3D) position (latitude, longitude and height) of the corresponding train with respect to a terrestrial reference frame. In order to compute an accurate 3D position of a corresponding train, a GNSS receiver needs to be in an unobstructed line of sight to three or more GNSS satellites. Such a requirement is, however, difficult to maintain permanently over the time in the context of rail transport where the trains run between mountains and buildings, and cross bridges and tunnels. The presence of such obstacles blocks the GNSS signals from reaching the GNSS receiver, and results in an inaccurate positioning of the train. In addition, even in the absence of obstacles between the GNSS satellites and the GNSS receiver, an accurate positioning of a train requires a precise time synchronization between the clocks on board the GNSS satellites that rule the generation of the GNSS signals and the clock equipping the GNSS receiver that is required for the properly decoding of the received GNSS signals. Generally, very stable atomic clocks are carried by the GNSS satellites, while the GNSS receivers use of less stable and less precise clocks which can be subject to time drift. For example, a time drift of 1 μm in the GNSS receiver's clock may lead to dozens of meters of inaccuracy in the positioning of the corresponding train. Such an imprecision level makes the use of a simple GNSS receiver incompatible with the rail transport where a high precision is required, for example to determine in which track of a station a train being stationary.

Thus, there is a need for an improved positioning device which does not have the drawbacks of the state of the art.

### SUMMARY

In order to address these and other problems, there is provided a positioning device configured to determine the location of a vehicle from positioning signals broadcasted by at least one constellation of satellites, the vehicle being stationary or moving on the roads of a given network. The positioning device comprises:
a first unit configured, at a given measurement time, to determine a plurality of possible current positions of the vehicle and to determine a plurality of time stamps, the plurality of time stamps being determined within a given time interval, the first unit being further configured to:
   generate, for each possible current position of the vehicle, local replicas of positioning signals, each of the local replicas being associated with an early, a prompt and a late point of a time stamp of the plurality of time stamps and with a satellite in view of the at least one constellation of satellites;
   receive, at each time stamp of the plurality of time stamps, positioning signals broadcasted by at least three satellites in view of the at least one constellation of satellites;
   process, for each possible current position of the vehicle, for each time stamp of the plurality of time stamps, and for each satellite in view, a correlation function between a received positioning signal and the corresponding generated local replica at the early, prompt and late points;
a second unit configured to:
   for each satellite, use the correlation results to determine a common error to all the satellites,
   for each satellite, each position and each time stamp, determine a corrected correlation result using the said common error and the early, prompt and late points of the correlation results,
   determine, for each possible current position of the vehicle, multi-satellite likelihoods, each of the multi-satellite likelihoods being determined for a given time stamp from the quadratic sum of the corrected correlation results;
   determine a most likely position and a most likely time stamp among the plurality of possible current positions and among the plurality of time stamps, respectively, by comparing the multi-satellite likelihoods.

According to some embodiments, the step of determining a common error to all the satellites comprises:
for each satellite:
   determining the possible position having the maximum correlation result,
   from said possible position, drawing a line perpendicular to an axis directed towards the said satellite,
   measuring, for each position, the minimum distance to the said line, and
   multiplying said minimum distance by the cosine of the satellite elevation angle to obtain a temporal distance, or
for each satellite and each possible position:
   implement a Newton interpolation over the correlation results at the early, prompt and late points of the time stamp having the maximum results,
   determine a temporal distance between the prompt position of the time stamp and the maximum of the interpolated correlation,
determine the possible position having the closest temporal distance for each of the satellites, and compute the common error as the mean of the temporal distances of the satellites for said possible position.

According to some embodiments, processing, for each possible current position of the vehicle and each time stamp of the plurality of time stamps, a correlation function between a received positioning signal and the corresponding generated local replica at an early, prompt and late point comprises accumulating a plurality of correlations results computed within a limited time interval around the said early, prompt and late points of the time stamp.

According to some embodiments, the positioning device may further comprise a cartographic database comprising position information of the roads of the given network, the second unit being further configured to determine the section of road the vehicle is on by accessing the cartographic database and using the determined most likely position.

According to some embodiments, the cartographic database may further comprise a representation of the surrounding environment of the roads of the given network.

According to some embodiments, the first unit may further be configured to access the cartographic database to determine one or more propagation characteristics of each of the received positioning signals, the first unit being further configured to exclude from the elementary likelihood computing one or more positioning signals on the basis of their propagation characteristics.

According to some embodiments, the first unit may be configured, when the vehicle is moving, to determine the plurality of possible current positions by using a PVT technique in conjunction with a plurality of positioning signals.

According to some embodiments, the first unit may be configured, when the vehicle is stationary on a parking road among a plurality of adjacent parking roads, to determine the plurality of possible current positions by assigning a possible current position to each of the adjacent parking roads.

According to some embodiments, the first unit may further be configured to determine the given time interval on the basis of a temporal integrity protection radius associated with the at least one constellation of satellites.

According to some embodiments, the first unit may further be configured to determine the plurality of time stamps by regularly sampling during the given time interval.

According to some embodiments, the first unit may be configured to receive positioning signals from two or more constellations of satellites, the first unit being further configured to process separately the positioning signals broadcasted by each of the constellations of satellites, the second unit being configured to determine a most likely position and a most likely time stamp for each of the constellations of satellites, the second unit being further configured to determine a final most likely position among the determined most likely positions.

According to some embodiments, the second unit may be configured to use a selection criterion to determine the final most likely position, the selection criterion being chosen among the following selection criteria:
the number of satellites per constellation involved in determining each most likely position, the final most likely position being determined using a maximum number of satellites in view; or
the duration of the given time interval, the final most likely position being determined using the constellation of satellites associated with the shortest given time interval.

According to some embodiments, the second unit may further be configured to generate an alert notification if it is unable to determine a most likely position of the vehicle within a predefined time interval.

There is also provided a method for determining the location of a vehicle using positioning signals broadcasted by at least one constellation of satellites. The method comprises the steps of:
determining a plurality of possible current positions of the vehicle, and determining a plurality of time stamps within a given time interval;
generating, for each possible current position of the vehicle, local replicas of positioning signals, each of the local replicas being associated with an early, a prompt and a late point of a time stamp of the plurality of time stamps and with a satellite in view of the at least one constellation of satellites;
receiving, at each time stamp of the plurality of time stamps, positioning signals broadcasted by at least three satellites in view of the at least one constellation of satellites;
processing, for each possible current position of the vehicle, for each time stamp of the plurality of time stamps, and for each satellite in view, a correlation function between a received positioning signal and the corresponding generated local replica at the early, prompt and late points;
determining a common error to all the satellites using the correlation results;
for each satellite, each position and each time stamp, correcting (406) the correlation results using the said common error and the early, prompt and late points of the correlation results, determining, for each possible current position of the vehicle, multi-satellite likelihoods, each of the multi-satellite likelihoods being determined for a given time stamp from the quadratic sum of the corrected correlation results, and determining a most likely position and a most likely time stamp among the plurality of possible current positions and among the plurality of time stamps, respectively, by comparing the multi-satellite likelihoods.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 represents a vehicle positioning system, according to some embodiments of the invention;

FIG. 2 schematically illustrates the structure of a positioning device, according to some embodiments of the invention;

FIG. 3 illustrates the acquisition of positioning signals, according to one embodiment of the invention;

FIG. 4 is a flowchart illustrating a positioning process, according to one embodiment of the invention.

### DETAILED DESCRIPTION

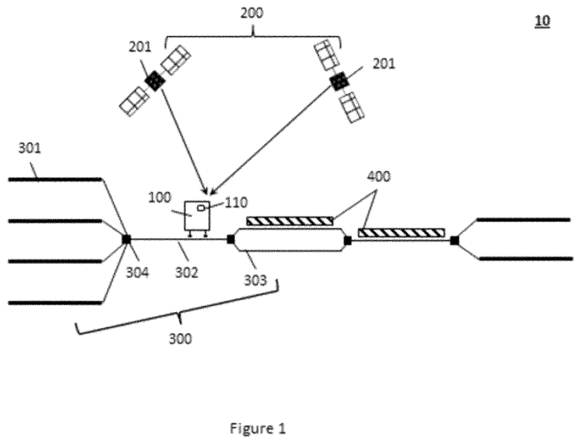

FIG. 1 shows a vehicle location system 10 where a positioning device 110 may be used, according to some embodiments of the invention. The vehicle location system 10 comprises several roads belonging to a given network 300, the roads being arranged according to a given architecture. The vehicle location system 10 further comprises one or more vehicles 100, each of the vehicles 100 being constrained to evolve exclusively on the roads of the given network 300. For example, the roads of the given network 300 may stand for the tracks of a rail transport system. In such an example, the vehicles 100 are rail vehicles 100 that may be, without limitation, trains or subways. Each of the vehicles 100 comprises a positioning device 110 that may be configured to determine the instantaneous position of the corresponding vehicle by using externally-provided positioning signals.

The vehicle location system 10 further comprises a constellation 200 of satellites comprising several satellites 201. The number of satellites 201 forming the constellation, as well as their orbiting characteristics, may be determined beforehand so as to guarantee that each positioning device 110 is covered at any time by at least one satellite of the constellation. This allows the positioning device 110 to receive positioning signals provided by at least one satellite of the constellation 200 at all times. It is to point out that a positioning signal transmitted by a satellite of the constellation 200 may be subjected, before reaching the positioning device 110, to various distortions such as multipath interference. Those distortions may be caused by several phenomena including the diffraction by natural obstacles or buildings. Some of those distortions may be deterministic in which case they can be merely compensated for by the positioning device 110. Some other distortions are, however, probabilistic and require a high processing complexity in order to properly decode the positioning signals. In addition, each of the satellites 201 of the constellation 200 comprises an onboard clock that is configured to rule the generation of the positioning signals. Advantageously, the clock onboard in each satellite of the constellation 200 may be an atomic clock which exhibits more stable and more precise when compared to other types of clocks.

The given network 300 comprises several switches 304 inserted between the roads and configured to guide vehicles 100 from one road to another. The use of switches 304 allows the vehicles 100 to share common roads 302. In the example of a railway network 300, a switch is a mechanical installation enabling rail vehicles 100 to be guided from one track to another.

The given network 300 further comprises several parking roads 301 serving to park the vehicles 100 when they are not serving and/or when they are out of service, for example. In addition, some of the parking roads 301 may be arranged in a parallel way and connected to a common road 302 by means of a switch. Generally, a parking road may be seen as a starting or an ending point for one or more corresponding vehicles 100. Each of the parking roads 301 may be assigned to a unique identifier. In some embodiments, the positioning device 110 may be configured, when the corresponding vehicle is stationary on a parking road, to determine the parking road on which the corresponding vehicle is stationary by returning its unique identifier, for example.

The given network 300 further comprises several common roads 302 on which multiple vehicles 100 may run in series. In the example of a railway network 300, several rail vehicles 100 may run on a same track in a common direction of travel. In addition, each of the common roads 302 may be seen as an association of a plurality of sections, each of the section being assigned to a unique identifier. In some embodiments, the positioning device 110 may be configured, when the corresponding vehicle is moving on a common road 302, to determine the section of the common road 302 on which the corresponding vehicle is located by returning its unique identifier, for example.

The given network 300 may further comprise one or more stations in which a vehicle may stay temporarily to load passengers onboard, for example. In addition, each of the stations may comprise several parallel station roads 303; each of the station roads 303 may for example be associated to a platform. Advantageously, each of the station roads 303 may be assigned to a unique identifier. In some embodiments, the positioning device 110 may be configured, when the corresponding vehicle is entering a station, to determine the station road on which the corresponding vehicle is moving by returning its unique identifier, for example.

In some embodiments of the invention, the positioning device 110 may be configured to determine a parking road, a section of a common road 302 or a station road of the corresponding vehicle by using one or more positioning signals provided by the constellation 200 of satellites and using the architecture of the given network 300.

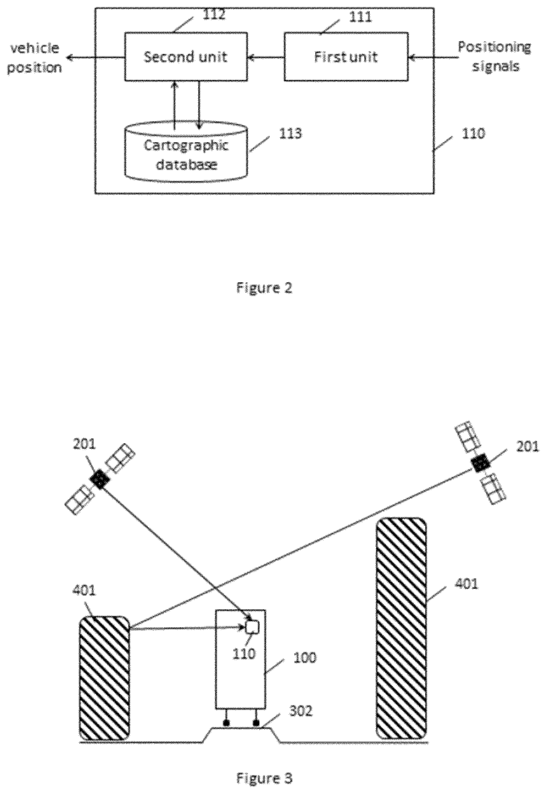

FIG. 2 illustrates the structure of a positioning device 110 according to some embodiments of the invention. The following description of the positioning device 110 is made with reference to a railway network 300. Those skilled in the art will easily understand that the positioning device 110 according to the various embodiments of the invention may easily be extended to other types of transport networks where the vehicles 100 are constrained to evolve exclusively on the roads of the given network 300. Advantageously, the positioning device 110 comprises a first unit 111, the first unit 111 being configured to determine, at a given measurement time, several possible current positions of the rail vehicle. The possible current positions of the rail vehicle may be determined on the basis of one or more parameters such as the state of the rail vehicle, e.g. stationary or moving, the lastly known position of the rail vehicle, the velocity of the rail vehicle, and so on. For example, when the rail vehicle is parking on one of several adjacent parking tracks 301, the first unit 111 may be configured to determine the possible current positions of the rail vehicle by assigning a possible current position for each of the adjacent parking tracks 301. In another example where the rail vehicle is running on a common track 302 of the railway network 300, the first unit 111 may be configured to determine the possible current positions of the rail vehicle by assigning a possible current position for each of the sections of the common track 302. Given the length of a rail vehicle, a possible current position of a rail vehicle may precisely correspond to the possible current position of its locomotive.

The positioning device 110 further comprises a clock that rules the decoding of the positioning signals provided by the constellation 200 of satellites. In one embodiment of the invention, the clock equipping the positioning device 110 is synchronized with the clocks onboard the satellites 201 of the constellation 200 that rule the generation of the positioning signals. In such an embodiment, the first unit 111 is further configured to determine a time stamp that may correspond to the given measurement time.

In another embodiment of the invention, the clock equipping the positioning device 110 is not synchronized with one or more clocks on board the satellites 201 of the constellation. In such an embodiment, the first unit 111 may be configured to determine a given time interval on the basis of the timing mismatch between the two clocks. The first unit 111 may further be configured to determine a plurality of time stamps within the given time interval. For example, the time stamps may be obtained by linearly sampling the given time interval. The given time interval may further be determined as a function of the speed of the rail vehicle. For example, the higher the speed of the rail vehicle is, the shorter the given time interval is. A special case is when the rail vehicle is stationary, the given time interval can be as long as possible depending on predefined positioning time requirements.

The first unit 111 may further be configured to generate, for each possible current position of the rail vehicle, one or more local replicas of positioning signals, each of the local replicas of positioning signals being associated with a time stamp at an early, prompt and late point, and with a satellite in view of the constellation 200 of satellites. Each of the local replicas of positioning signals is generated by the first unit 111 on the basis of the position of the corresponding satellite in view which is supposed precisely known by the first unit 111 of the positioning device 110. In general, the received navigation messages comprises an ephemeris field comprising information related to the position of the satellite transmitting the positioning signal, and may further comprise an almanac field comprising information about the orbit of each satellite of the constellation.

The first unit 111 may further be configured to receive, at each time stamp of the plurality of time stamps, positioning signals broadcasted by at least three satellites 201 of the constellation, the at least three satellites 201 of the constellation 200 being visible by the positioning device 110. Each of the positioning signals may be made of a navigation message modulated by a spreading sequence, generally a pseudo random noise (PN). A positioning signal may be subjected to various distortions before reaching the positioning device 110. Advantageously, the first unit 111 may further be configured to compensate for such distortions before making use of the positioning signals to determine the location of the corresponding rail vehicle.

The first unit 111 may further be configured to compute, for each possible current position of the rail vehicle, a correlation between a positioning signal and its local replica at an early, a prompt and a late point of a given time stamp of the plurality of time stamps and a given satellite in view of the constellation 200 of satellites.

Advantageously, each of these correlations can be a coherent or non-coherent accumulation of a plurality of correlations performed between the positioning signal and its local replica for a plurality of time stamps within a given time interval around the given time stamp. The size of the given time interval may depend on the velocity of the train, so that the position of the vehicle does not vary significantly during the given time interval. It can therefore be of several minutes when the rail vehicle is immobile, to a few hundred nanoseconds when the rail vehicle is at full speed. This step of accumulating the results of correlations performed in a time interval in which the rail vehicle movement is not significant helps reducing the noise level of the measurement, thereby improving the quality of the position measurement.

The positioning device 110 further comprises a second unit 112, the second unit 112 being configured to receive the correlations results calculated by the first unit 111, along with the possible current positions and time stamps. Further, the second unit 112 may be configured to:
determine a common error to each of the satellites from the correlation results,
correct the correlation results using said common error, and
use the corrected correlation results to determine a most likely possible current position and a most likely time stamp among the possible current positions and among the plurality of time stamps.

The positioning device 110 may further comprise a cartographic database 113 comprising a representation of the railway network 300. For example, the cartographic database 113 may comprise the 3D coordinates of the center line of each of the tracks of the railway network 300. Advantageously, only samples of the center line of the tracks may be contained in the cartographic database 113. This considerably reduces the amount of data contained in the database. Further, the minimal distance between two adjacent samples of the center line may vary depending on whether there is a track ambiguity issue to solve or not. The track ambiguity issue arises for example when the rail vehicle is on a parking track among several adjacent parking tracks 301. In this example, the minimal distance may be chosen less than the minimal distance separating two adjacent tracks, for example less than four meters. In a scenario where there is no track ambiguity issue such as when the rail vehicle is running on a common track 302, the minimal distance between two adjacent samples of center line may be determined based on a predefined precision threshold.

In one embodiment of the invention, the cartographic database 113 may further comprise a representation of the environment 400 that surrounds the tracks of the railway network 300. Such a representation may concern the elements of the surrounding environment 400 that may impact, i.e. distort, the positioning signals before reaching the positioning device 110. For example, only the elements of the surrounding environment 400 which are located in a predefined interval centered at the level of the track may be considered. More precisely, the cartographic database 113 may contain, for each of the considered elements, several characteristics that may include geometric characteristics (length, height, width, distance from the center line of the track, etc.).

In another embodiment of the invention, the second unit 112 may further be configured to determine the track on which the rail vehicle is located by accessing the cartographic database 113 and entering the already determined most likely position. For example, in a scenario where the rail vehicle is parking on a parking track among several parking tracks 301, the second unit 112 may be configured to determine the unique identifier of the parking track on which the rail vehicle is being parked. In another scenario, where the rail vehicle is running on a common track 302, the second unit 112 may be configured to determine the section of the common track 302 on which the rail vehicle is located.

In one embodiment of the invention, the first unit 111 of the positioning device 110 may be configured to determine the plurality of possible current positions using a PVT (Position-Velocity-Time) technique consisting in determining distances between the positioning device 110 and each of the satellites 201 in view, such distances being known as “pseudo-ranges”. When three pseudo-ranges are calculated, the first unit 111 may be configured to determine its 3D coordinates, which represents a possible current position of the rail vehicle, knowing the satellites 201 positions. When four or more pseudo-ranges are calculated, the first unit 111 may be configured to determine from each combination of three pseudo-ranges a corresponding possible current position of the rail vehicle. In addition, the first unit 111 of the positioning device 110 may further be configured to access the cartographic database 113 in order to reduce the number of possible current positions of the rail vehicle, as the rail vehicle is constrained to only run on the tracks of the railway network 300.

In another embodiment of the invention, the first unit 111 of the positioning device 110 may be configured to determine the plurality of possible current positions by using models and/or assumptions that rule the motion of the rail vehicle on the tracks of railway network 300. Advantageously, the determination of the plurality of possible current positions may also take into account externally-provided information that may be supplied by other devices equipping the rail vehicle. Such externally-provided information may include the instantaneous velocity of the train, an approximate location of rail vehicle as it may be determined by an inertial measurement unit (IMU) and/or a previously determined location of the rail vehicle. In addition, the first unit 111 of the positioning device 110 may further be configured to access the cartographic database 113 in order to reduce the number of possible current positions of the rail vehicle, as the rail vehicle is constrained to only run on the tracks of the railway network 300.

The first unit 111 of the positioning device 110 may be configured to determine the given time interval for a given constellation 200 of satellites basing on a temporal integrity protection radius, which may be calculated from the temporal data of a RAIM function, integrated in or external to the positioning device 110.

In one embodiment of the invention, the positioning device 110 may be configured to receive, at a given measurement time, positioning signals provided by satellites 201 belonging to two or more constellations 200 of satellites 201. In such an embodiment, the positioning device 110 may be configured to process independently the positioning signals provided by each constellation 200 of satellites as described above in relation with a single constellation 200 of satellites, thus a most likely possible current position is determined for each constellation 200 of satellites. Further, the positioning device 110 may be configured to select a final most likely possible current position among the plurality of the determined most likely possible current positions. Such a selection operation may for example be carried out on the basis of a selection criterion. The selection criterion may for example be the number of satellites 201 in view involved in determining a corresponding most likely position. In this case, the most likely position determined using a maximum number of satellites 201 may be taken as the final most likely position.

In another embodiment of the invention, the selection criterion used by the positioning device 110 to determine a final most likely position among a plurality of most likely positions may be the duration of the given time interval. In this case, the most likely possible current position associated with the shortest given time interval may be taken as the final most likely position.

In one embodiment of the invention, the positioning device 110 may be configured to implement an integrity monitoring to generate an alert notification when it is unable to locate the corresponding rail vehicle within a predefined measurement time interval, the predefined measurement time interval being measured from the given measurement time. This may for example occur when the rail vehicle enters areas of degraded coverage and/or in difficult weather conditions. The duration of the predefined measurement time interval may be dependent on whether the rail vehicle is stationary or moving. The generated alert notification may for example be transmitted to the driver of the rail vehicle.

FIG. 3 illustrates the acquisition of positioning signals, according to one embodiment of the invention. The positioning device 110 receives positioning signals from two satellites 201 in view belonging to a common constellation 200 of satellites. The positioning signals broadcasted by one of the two satellites 201 reach the positioning device 110 according to a line-of-sight propagation, i.e. the positioning signals travel in a direct path from the satellite to the positioning device 110. The positioning signals broadcasted by the other satellite are subjected to multi-path propagation before reaching the positioning device 110. The first unit 111 of the positioning device 110 may be configured to access the cartographic database 113 and to determine the propagation characteristics of each of the received positioning signals, knowing, for example and without limitation, the position of the corresponding satellite, the possible current position of the rail vehicle, the characteristics of the surrounding environment 400 as provided by the cartographic database 113. The first unit 111 may further be configured to exclude from the elementary likelihood computing one or more positioning signals on the basis of their propagation characterizes. For example, only the positioning signals reaching the positioning device 110 according to a line-of-sight propagation may be included, by the first unit 111, in the correlation computing. This enhances the accuracy of the positioning of the rail vehicle.

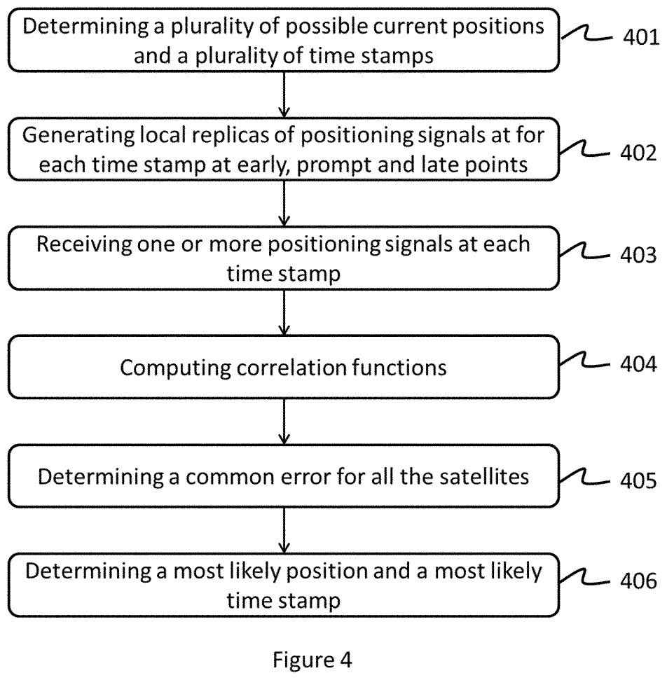

FIG. 4 is a flowchart illustrating a positioning process of a rail vehicle, which may be implemented at the positioning device 110, in accordance with an embodiment of the invention. At step 401, a plurality of possible current positions of a rail vehicle evolving on the tracks of a railway network 300 is determined at a given measurement time. Neither the position of a previous time or train movement is necessary. The plurality of possible current positions may be determined using a PVT technique in conjunction with a plurality of positioning signals broadcasted by the satellites 201 of at least one constellation 200 of satellites. Step 401 further consists in determining a plurality of time stamps, the time stamps being determined within a given time interval. For example, the plurality of time stamps may be determined by regularly or irregularly sampling the given time interval. Further, the given time interval may be determined in advance on the basis of a temporal integrity protection radius associated with the at least one constellation 200 of satellites.

At step 402, local replicas of positioning signals are generated for each possible current position of the rail vehicle, each of the local replicas being associated with an early, prompt and late point of a time stamp of the plurality of time stamps and with a satellite in view of the at least one constellation 200 of satellites. The early and late points have an equal absolute timing offset to the prompt point of the time stamp. For instance, the early point can be taken with a timing offset of −100 ns to the prompt point, and the late point can be taken with a timing offset of +100 ns to the prompt point.

At step 403, positioning signals broadcasted by the satellites 201 in view of the at least one constellation 200 of satellites are received at each time stamp of the plurality of time stamps.

At step 404, a correlation function between a received positioning signal sent by a satellite and the corresponding generated local replicas at the early, prompt and late point is computed for each possible current position of the rail vehicle, of each time stamp of the plurality of time stamps, and for at least three satellites of the at least one constellation 200 of satellites.

Advantageously, in an embodiment, each correlation corresponds to an accumulation of correlations performed over a given time interval around each early, prompt and late time points of the time stamps. The accumulation may be coherent or non-coherent. It helps reducing the noise level of the measurements, which improves the positioning's accuracy.

At step 405, a common error to each of the satellites is calculated from the correlation results. Indeed, for each satellite, the errors that affect measurements are:

the receiver timing error, which is the error due to a shift between the clock of the satellites and the clock of the rail vehicle,
the balise position error, which corresponds to the distance between the rail vehicle and the possible position,
the residual propagation delay, which is the bias between the ionospheric and tropospheric delays provided by models (for instance the Klobuchar model) and their actual delays.

The residual propagation delay tends to be similar for all the satellites, and the receiver timing error is exactly the same for all the satellites. A correlation maximum can be observed on the possible positions of the rail vehicle when the balise position error is close to the residual propagation delay minus the receiver timing error. This means that, for each satellite, the balise position error is equal to their maximum correlation points.

Therefore, a common error to each of the satellites can be calculated based on the positions where the correlations are at their maximum for each satellite.

In an embodiment, the common error is computed in a graphical way: for each satellite, the possible position having the maximum correlation result is determined. From this position, a line perpendicular to a line joining the possible position to the satellite is drawn. This line corresponds to an approximation of a circular arc equidistant to the satellite: all the points of the line show the same maximum correlation result.

For each possible position and each satellite in view, the minimum distance to the maximum correlation line is measured. This spatial distance is multiplied by the cosine of the satellite elevation angle to be transformed into a temporal distance.

The best possible position of the rail vehicle corresponds to the possible position having the closest temporal distance for each of the satellites, that is to say to the possible position minimizing the difference between the maximum and minimum temporal distance for each of the satellites. For this best possible position, the common error can be calculated, which is equal to the mean of the temporal distance to each of the satellites.

In another embodiment, the common error is determined using the early, prompt and late correlation results. For each satellite, each possible position, and the time stamp corresponding to the maximum correlation result, the early, prompt and late correlation results are interpolated (for instance through a Newton interpolation) to determine an accurate correlation maximum. The offset of the accurate correlation maximum to the prompt correlator is equal to the temporal distance for this possible position.

As of in the previous embodiment, the best possible position of the rail vehicle corresponds to the possible position having the closest temporal distance for each of the satellites, that is to say the possible position minimizing the difference between the maximum and minimum temporal distance for each of the satellites. From this best possible position, the common error can be calculated, which is equal to the mean of the temporal distance to each of the satellites.

At step 406, the correlation results calculated for each of the possible satellites and each of the possible time stamps are corrected using the common error. The corrected correlation result can be found by, for each possible position, each time stamp and each satellite, interpolating the correlation results using for instance a Newton interpolation over the early, prompt and late correlation results, the corrected correlation value being given by the interpolated correlation results at a position equal to the prompt position of the time stamp shifted by the common error value.

Then, a multi-satellite likelihood is computed for each possible current positions and each possible time stamp, as the quadratic sum of the corrected correlation results of each of the satellites. Finally, a most likely position and a most likely time stamp among the plurality of possible current positions and among the plurality of time stamps, respectively, are determined by comparing the multi-satellite likelihoods. For example, the most likely position and the most likely time stamp may correspond to a maximum of multi-satellite likelihood. The most likely position is a final most likely position if the positioning signals are broadcasted from satellites 201 belonging to a common constellation 200 of satellites.

This position is unique, as the correlation results considered to determine the position have been corrected of the common error.

In one embodiment of the invention, the positioning process may further comprise a step consisting in determining, if the rail vehicle is stationary, the parking track on which the rail vehicle is parking by accessing a cartographic database 113.

In another embodiment of the invention, the positioning process may further comprise a step consisting in determining, if the rail vehicle is moving, the section of the track on which the rail vehicle is located by accessing a cartographic database 113.

It should be noted that the functions, acts, and/or operations specified in the flow charts, sequence diagrams, and/or block diagrams may be re-ordered, processed serially, and/or processed concurrently consistent with embodiments of the invention. Moreover, any of the flow charts, sequence diagrams, and/or block diagrams may include more or fewer blocks than those illustrated consistent with embodiments of the invention.

While embodiments of the invention have been illustrated by a description of various examples, and while these embodiments have been described in considerable detail, it is not the intent of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described.

1. A positioning device configured to determine the location of a vehicle from positioning signals broadcasted by at least one constellation of satellites, the vehicle being stationary or moving on the roads of a given network, the positioning device comprising:
a first unit configured, at a given measurement time, to determine a plurality of possible current positions of the vehicle and to determine a plurality of time stamps, the plurality of time stamps being determined within a given time interval, the first unit being further configured to:
generate, for each possible current position of the vehicle, local replicas of positioning signals, each of the local replicas being associated with an early, a prompt and a late point of each time stamp of the plurality of time stamps and with a satellite in view of the at least one constellation of satellites;
receive, at each time stamp of the plurality of time stamps, positioning signals broadcasted by at least three satellites in view of the at least one constellation of satellites;
process, for each possible current position of the vehicle, for each time stamp of the plurality of time stamps, and for each satellite in view, a correlation function between a received positioning signal and the corresponding generated local replica at the early, prompt and late points;
a second unit configured to:
for each satellite, use the correlation results to determine a common error to all the satellites,
for each satellite, each position and each time stamp, determine a corrected correlation result using the said common error and the early, prompt and late points of the correlation results,
determine, for each possible current position of the vehicle, multi-satellite likelihoods, each of the multi-satellite likelihoods being determined for a given time stamp from the quadratic sum of the corrected correlation results;
determine a most likely position and a most likely time stamp among the plurality of possible current positions and among the plurality of time stamps, respectively, by comparing the multi-satellite likelihoods.

2. The positioning device of claim 1, wherein the step of determining a common error to all the satellites comprises:
for each satellite:
determining the possible position having the maximum correlation result,
from said possible position, drawing a line perpendicular to an axis directed towards the said satellite,
measuring, for each position, the minimum distance to the said line, and
multiplying said minimum distance by the cosine of the satellite elevation angle to obtain a temporal distance, or
for each satellite and each possible position:
implement a Newton interpolation over the correlation results at the early, prompt and late points of the time stamp having the maximum correlation result,
determine a temporal distance between the prompt position of the time stamp and the maximum of the interpolated correlation,
determine the possible position having the closest temporal distance for each of the satellites, and compute the common error as the mean of the temporal distances for all the satellites for said possible position.

3. The positioning device of claim 1, wherein processing, for each possible current position of the vehicle and for each time stamp of the plurality of time stamps, a correlation function between a received positioning signal and the corresponding generated local replica at an early, prompt and late point comprises accumulating a plurality of correlations results computed within a given time interval around the said early, prompt and late points of the time stamp.

4. The positioning device of claim 1, wherein it further comprises a cartographic database comprising position information of the roads of the given network, the second unit being further configured to determine the section of road the vehicle is on by accessing the cartographic database and using the determined most likely position.

5. The positioning device of claim 4, wherein the cartographic database further comprises a representation of the surrounding environment of the roads of the given network.

6. The positioning device of claim 5, wherein the first unit is further configured to access the cartographic database to determine one or more propagation characteristics of each of the received positioning signals, the first unit being further configured to exclude from the elementary likelihood computing one or more positioning signals on the basis of their propagation characteristics.

7. The positioning device of claim 1, wherein the first unit is configured, when the vehicle is moving, to determine the plurality of possible current positions by using a PVT technique in conjunction with a plurality of positioning signals.

8. The positioning device of claim 5, wherein the first unit is configured, when the vehicle is stationary on a parking road among a plurality of adjacent parking roads, to determine the plurality of possible current positions by assigning a possible current position to each of the adjacent parking roads.

9. The positioning device of claim 1, wherein the first unit is further configured to determine the given time interval on the basis of a temporal integrity protection radius associated with the at least one constellation of satellites.

10. The positioning device of claim 1, wherein the first unit is further configured to determine the plurality of time stamps by regularly sampling during the given time interval.

11. The positioning device of claim 1, wherein the first unit is configured to receive positioning signals from two or more constellations of satellites, the first unit being further configured to process separately the positioning signals broadcasted by each of the constellations of satellites, the second unit being configured to determine a most likely position and a most likely time stamp for each of the constellations of satellites, the second unit being further configured to determine a final most likely position among the determined most likely positions.

12. The positioning device of claim 12, wherein the second unit is configured to use a selection criterion to determine the final most likely position, the selection criterion being chosen among the following selection criteria:
the number of satellites per constellation involved in determining each most likely position, the final most likely position being determined using a maximum number of satellites in view; or
the duration of the given time interval, the final most likely position being determined using the constellation of satellites associated with the shortest given time interval.

13. The positioning device of claim 1, wherein the second unit is further configured to generate an alert notification if it is unable to determine a most likely position of the vehicle within a predefined time interval.

14. A method for determining the location of a vehicle using positioning signals broadcasted by at least one constellation of satellites, the method comprising the steps of:
determining a plurality of possible current positions of the vehicle, and determining a plurality of time stamps within a given time interval;
generating, for each possible current position of the vehicle, local replicas of positioning signals, each of the local replicas being associated with an early, a prompt and a late point of each time stamp of the plurality of time stamps and with a satellite in view of the at least one constellation of satellites;
receiving, at each time stamp of the plurality of time stamps, positioning signals broadcasted by at least three satellites in view of the at least one constellation of satellites;
processing, for each possible current position of the vehicle, for each time stamp of the plurality of time stamps, and for each satellite in view, a correlation function between a received positioning signal and the corresponding generated local replica at the early, prompt and late points;
determining a common error to all the satellites using the correlation results;
for each satellite, each position and each time stamp, correcting the correlation results using the said common error and the early, prompt and late points of the correlation results, determining, for each possible current position of the vehicle, multi-satellite likelihoods, each of the multi-satellite likelihoods being determined for a given time stamp from the quadratic sum of the corrected correlation results, and determining a most likely position and a most likely time stamp among the plurality of possible current positions and among the plurality of time stamps, respectively, by comparing the multi-satellite likelihoods.
